(19) United States
(12) Patent Application Publication
(10) Pub. No.: US 2009/0028663 A1
(43) Pub. Date: Jan. 29, 2009

(54) FASTENER COVER FOR LOW OBSERVABLE APPLICATIONS

(76) Inventor: Fred L. Stewart, Valencia, CA (US)

Correspondence Address: LOUIS L. DACHS, 1794 PALISADES DRIVE, PACIFIC PALISADES, CA, 90272, US

(21) Appl. No.: 11/430,731

(22) Filed: May 9, 2006

(51) Int. Cl. F16B 37/14

(52) U.S. Cl. 411/372.5

(57) ABSTRACT

The invention is a fastener cover for a fastener having a head and a shank portion, the head portion having a surface with a drive socket recess. In detail, the fastener cover includes a disc shaped member having first and second sides and having a surface area sufficient to cover the surface of the fastener head. The first side of the member having a recess in the shape of the drive socket recess in the center thereof such that when the member is placed on the head of the fastener the recess in the member is alignable with the drive socket recess. The second side of the member includes slit shaped opening extending to the first side, the slit in the shape of the recess in the first side. The cover includes a ring shaped layer of adhesive on the first side of the member extending about the periphery of the recess in the member.

### GOVERNMENT INTEREST

This invention was made under United States Air Force Contract Number HR0011-04-9-0009 dated August 2004. Therefore, the United States Government has rights to invention as set forth in that contract.

### BACKGROUND OF THE INVENTION

1. Field of the Invention

The invention relates to the field of fasteners and, in particular, to a cover for an installed fastener that provides for a reduction in radar signature while allowing access to the fastener head for removal purposes.

2. Description of Related Art

Typically, flush head type fasteners are used in low radar cross-section vehicles. Any gap between the fastener head recess and the fastener head is covered with filler made of radar absorbing material (RAM) with an excess material removed so that the external surface is smooth. However, if the fastener must be periodically removed, such a procedure is unacceptable. This is particularly true if the fastener is used to secure an access panel in the vehicle. Thus, one was left with just coating the fastener head with very thin layer of a RAM material

U.S. Pat. No. 6,315,485 Low Observable Aircraft Fastener Treatment by W. S. Speck, et al. discloses a low observable fastener for use with a panel structure requiring periodic removal. The panel structure has a RAM panel layer formed thereon. The RAM panel layer has a RAM panel layer bore formed there through aligned with the panel bore. The RAM panel layer bore defines an inner surface. Preferably, the inner surface is cylindrical or conical in shape. The fastener is provided with a fastener head for mating with the panel bore and which includes a removal tool engagement recess formed therein. The fastener is further provided with a donut shaped RAM treatment layer disposed upon the fastener head. The RAM treatment layer has a fastener access bore aligned with the tool engagement recess of the fastener head. The RAM treatment layer further has a cylindrical outer surface sized and configured to be concentrically received by the inner surface of the RAM panel layer. The cylindrical outer surface is sized and configured to absorb electromagnetic energy radiating from the inner surface of the RAM panel layer for mitigating radar emissions formed adjacent thereto. However, such a system or treatment, because of the access hole for the removal tool and the gap around the donut shaped treatment layer, does not provide optimum radar signature reduction.

Thus, it is a primary object of the invention to provide a low observable fastener cover.

It is another primary object of the invention to provide a low observable fastener cover that provides easy access to the fastener head for removal thereof.

It is a further object of the invention to provide a low observable fastener cover that provides easy access to the fastener head for removal thereof and completely covers the fastener head.

### SUMMARY OF THE INVENTION

The invention is a fastener cover assembly for a fastener having a head and a shank portion, the head portion having a surface with a drive socket recess. In detail, the fastener cover assembly includes a disc shaped member having first and second sides and having a surface area sufficient to cover the surface of the fastener head. The first side of the member having a recess in the shape of the drive socket recess in the center thereof such that when the member is placed on the head of the fastener the recess in the member is alignable with the drive socket recess. The second side of the member includes slit shaped opening extending to the first side, the slit in the shape of the recess in the first side. The cover includes a ring shaped layer of adhesive on the first side of the member extending about the periphery of the recess in the member. Thus when the disc shaped member is placed on the fastener head with the recess in the member in alignment with the drive socket, the ring shaped member can be placed in contract with the fastener head joining the member thereto. The disc shaped member is made up of a low dielectric material loaded with RAM.

The layer of adhesive can be a pressure sensitive silicone adhesive or the like. Preferably it is covered with a strippable film of protective material that can be removed prior to applying to the fastener head. The thickness of the cover assembly is selected so as to match the thickness of the any ram coating on the surface of the panel. The diameter of the cover

FIG. 2B is a view of the fastener head of the fastener shown in FIG. 1 having a different drive shot.

FIG. 2C is a view of the fastener head of the fastener shown in FIG. 1 having third kind of drive shot.

FIG. 3 is side a cross-sectional view of the fastener cover shown in FIG. 1.

FIG. 4A is a view of the underside of the cover shown in FIG. 3 used with the fastener shown in FIG. 2A.

FIG. 4B is a view of the underside of the cover shown in FIG. 3 used with the fastener shown in FIG. 2B.

FIG. 4C is a view of the underside of the cover shown in FIG. 3 used with the fastener shown in FIG. 2C.

FIG. 5A is a view of the top side of the cover shown in FIG. 3 used with the fasteners shown in FIGS. 2A and 2B.

FIG. 5B is a view of the top side of the cover shown in FIG. 3 used with the fastener shown in FIG. 2C.

FIG. 6 is a view of the fastener shown in FIG. 1 with a driver positioned to remove the fastener. assembly is equal to the diameter of the fastener head so that there is only an insignificant gap between the cover assembly and RAM covered panel.

For example if the fastener has a standard screw driver slot, the recess in the member is also a slot and there is a single slit in the second side of the member. A screw driver head can easily be driven through the slit and into the fastener head socket (screw driver slot) for removal of the fastener, to remove the panel from the structure. After the panel is reinstalled, the slit will close. Therefore, what is provided is a cover assembly that provides reduced RCS, while allowing access to the fastener for ease of removal.

The novel features which are believed to be characteristic of the invention, both as to its organization and method of operation, together with further objects and advantages thereof, will be better understood from the following description in connection with the accompanying drawings in which the presently preferred embodiment of the invention is illustrated by way of example. It is to be expressly understood, however, that the drawings are for purposes of illustration and description only and are not intended as a definition of the limits of the invention.

### BRIEF DESCRIPTION OF THE DRAWINGS

FIG. 1 is a partial cross-sectional view of a fastener installed in a panel for securing to a structure.

FIG. 2A is a view of the fastener head of the fastener shown in FIG. 1.

### DESCRIPTION OF THE PREFERRED EMBODIMENT

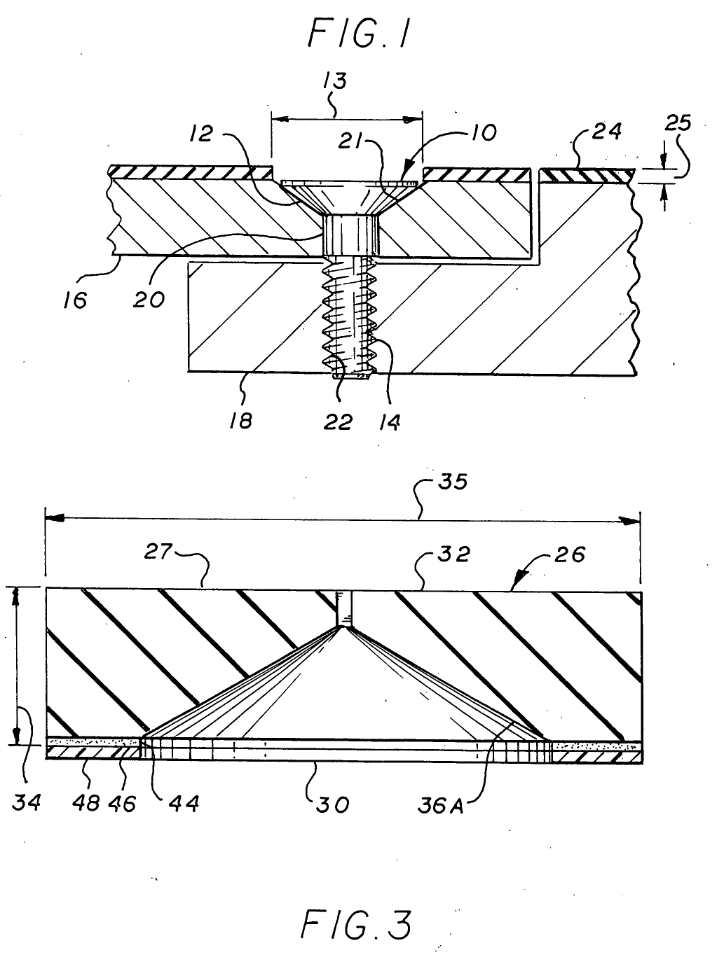

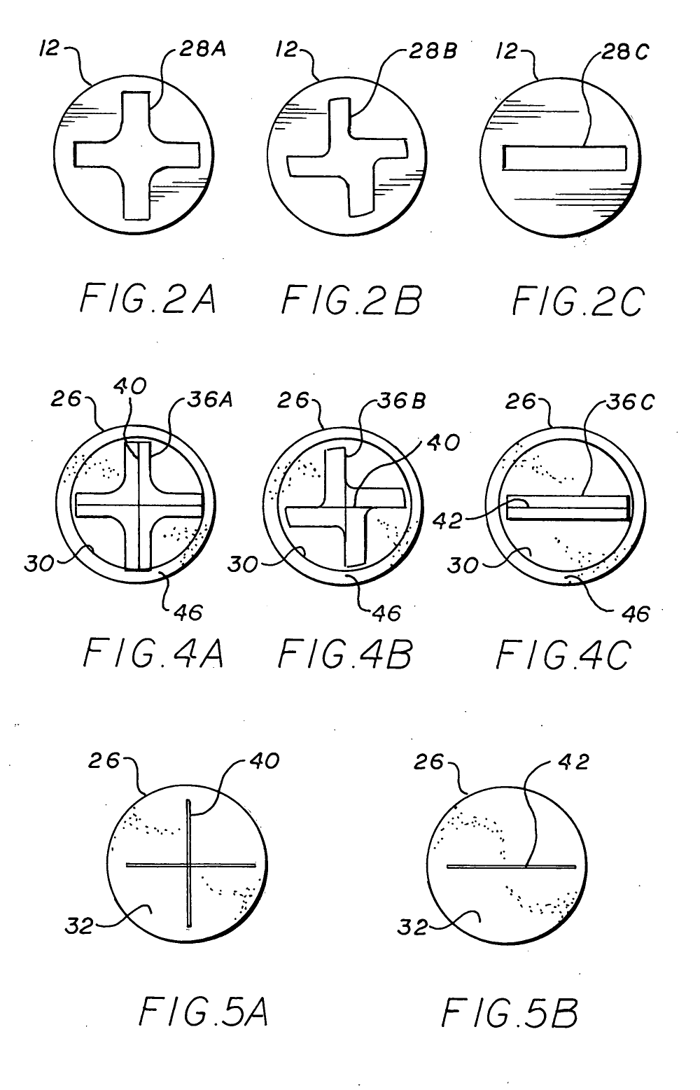

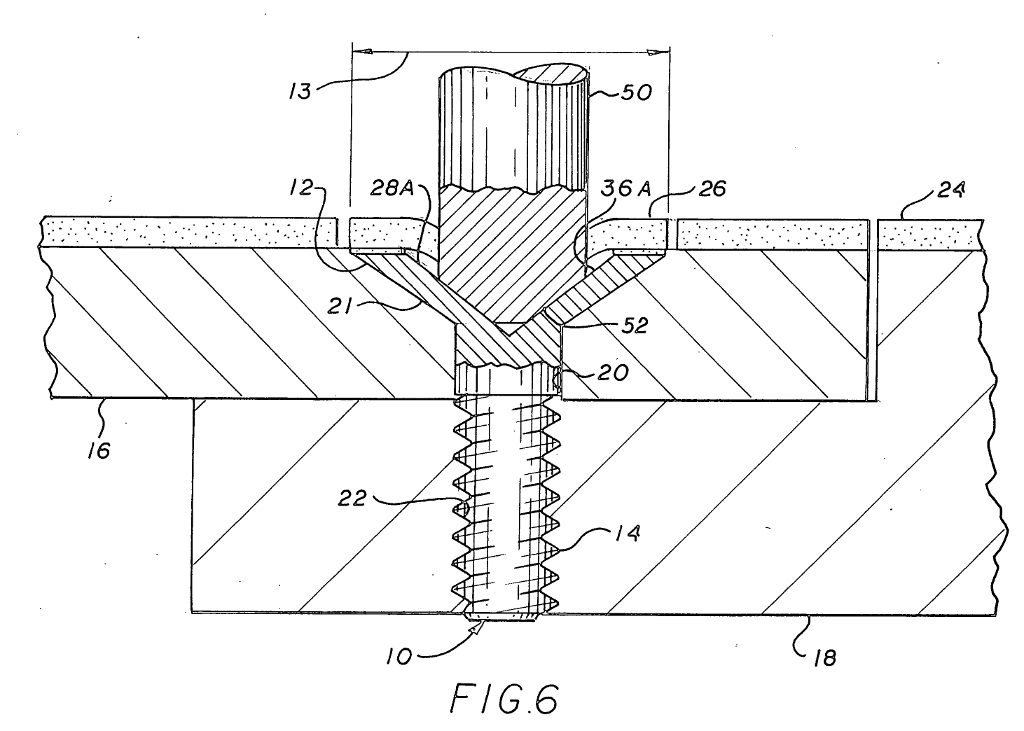

Referring to FIGS. 1 and 2A-2C a fastener, in this case a flush head type fastener 10 having a conical shaped head 12, with a diameter indicated by numeral 13, and threaded body 14 is shown securing a panel 16 to a structure 18. The fastener 10 is installed in a hole 20, having a counter sunk end 21 in the panel 16 and the threaded fastener body 14 engages a threaded hole 22, in the structure 18. If such a panel and structure are located on a low observable aircraft, where the radar cross-section (RCS) must be maintained at a minimum level, the use of flush head fasteners such as shown in FIG. 1 are a necessity. The aircraft panel 16 and structure 18 are also coated with a coating 24, having a thickness indicated by numeral 25, and containing a radar absorbing material. If the fastener was a permanent type not often requiring removal, the fastener head would also be coated. However, if the panel must be periodically removed, say after each flight, it is typically left uncoated. This of course, adversely effects the RCS of the aircraft, particularly so if the panel requires several fasteners for the securing thereof; which is usually the case. In FIG. 2A, the fastener 12 is shown with a standard Phillips recess drive socket 28A, in FIG. 2B, with a Torq-Set socket 28B and in FIG. 2C a standard screw driver slot 28C. The fastener 12 could also have an Allan wrench socket (not shown) or any other type of drive socket.

Still referring to FIGS. 1 and 2 and additionally to FIGS. 3-5, the subject invention, the cover assembly 26, is used to provide this RCS reduction. The cover 26 includes a disc shaped member 27 having a first side 30 (underside), and a second, (topside) 32 and has a thickness, indicated by numeral 34, and a diameter indicated by numeral 35. The first side 30 includes a recess 36A in the form of a recess socket similar to the Phillips socket 28A or the recess 36B in the form of a Toro-Set socket 28B or a recess 36C in the form of the screw driver slot 28C. The selection of the recess depends upon what type of drive socket the fastener has. The first side contains a slit that extends through to the recess. For example, if the recess is recess 36A or 36B, then the cross shaped split 40 shown in FIG. 5A is used. If the recess is recess 36C, then the slit is just a line 42 as shown in FIG. 5B.

The outer portion of the first side 30 of the member 27 includes a ring shaped portion 44 that is coated with an adhesive 46 for joining to fastener head 12. The member 27 can be made of Kapton™ obtainable from DuPont Corporation, Wilmington, Del., filled with a RAM. Other low dielectric materials include Silicone rubber. The only requirements are that the material be low dielectric, semi-elastic and capable being loaded with RAM. The layer of adhesive can be a pressure sensitive silicone adhesive or the like. Preferably covered with a strippable film of protective material 48, that can be removed prior to applying to the fastener head. The recess can be formed by laser cutting, punching, and melting or by die cutting. The thickness 34 of the cover assembly 26 is selected so as to match the thickness of the ram coating 24. The diameter 35 of the cover assembly 26 is approximately equal to the diameter 13 of the fastener head 12. However, it could be somewhat larger in diameter to fill in any gaps between the cover and ram coating 24.

Referring to FIG. 6, it can be seen that a screw driver 50 having an end 52 suitable for removing a fastener having Phillips head socket is shown thrust through the slit cross 40. Upon removal of the driver 50, the slit 40 returns to original position (closed). Therefore, what is provided is a cover assembly that provides reduced RCS, while allowing access to the fastener for ease of removal.

While the invention has been described with reference to a particular embodiment, it should be understood that the embodiment is merely illustrative as there are numerous variations and modifications, which may be made by those skilled in the art. Thus, the invention is to be construed as being limited only by the spirit and scope of the appended claims.

### INDUSTRIAL APPLICABILITY

The invention has applicability to fastener industry.

1. A fastener cover for a fastener having a head and a shank portion, the head portion having surface with a drive socket recess, the fastener cover comprising:
a disc shaped member having first and second sides and having a surface area sufficient to cover the surface of the fastener, said first side of said member having a recess in the shape of the drive socket recess in the center thereof such that when the member is place on the head of the fastener the recess in the member is alienable with the drive socket recess, said second side of said member having a slit extending said recess, said slit is in the shape of said recess in said first side; and
a ring shaped layer of adhesive on said first side of the member extending about the periphery of said recess in said member,
such that when said disc shaped member is placed on said fastener head with said recess in said member in alignment with the drive socket, said ring shaped member can be placed in contract with fastener head and joined thereto.

2. The fastener cover as set forth in claim 1 wherein the disc shaped member is made up of a low dielectric material loaded with RAM.

3. The fastener cover as set forth in claim 2 wherein the said disc shaped member is also made of a semi-elastic material.
